(19) United States
(12) Patent Application Publication
(10) Pub. No.: US 2008/0238132 A1
(43) Pub. Date: Oct. 2, 2008

(54) Folding Top for a Convertible

(76) Inventor: Rudolf Dietl, Munchen (DE)

Correspondence Address: DICKINSON WRIGHT PLLC, 1901 L. STREET NW, SUITE 800, WASHINGTON, DC, 20036, US

(21) Appl. No.: 12/063,695

(22) PCT Filed: Aug. 14, 2006
(86) PCT No.: PCT/DE06/01426

§ 371 Date: Feb. 13, 2008

(30) Foreign Application Priority Data
Aug. 15, 2005 (DE) 10 2005 038 703.9

(51) Int. Cl. B60J 7/08

(52) U.S. Cl. 296/108

(57) ABSTRACT

The invention relates to a folding top for a convertible, comprising a rod assembly (8) and a top (4, 19) which is mounted on the rod assembly (8). In order to create a modular folding top concept, the rod assembly (8) is provided with a fastening base that is designed for mounting different tops (4, 19). Furthermore, one respective top (4, 19) that is selected among a group of at least two tops which are formed differently especially regarding the movement functionalities thereof while having the same connecting dimensions is mounted on the fastening base to complete the folding top.

The invention relates to a folding canopy for a cabriolet vehicle having a canopy linkage and having a canopy peak which is attached to the canopy linkage, and to a method for producing a folding canopy of a cabriolet of said type.

Cabriolets with differently-designed folding canopies are known in large numbers. On account of different body shapes and sizes and differing requirements on functionality, there are more or less large differences in the design and configuration of the folding canopy which is to be provided for the respective cabriolet. Each folding canopy of a certain cabriolet is therefore an autonomous construction, which is designed and adapted for said type, and therefore also has only a certain, structurally defined functionality for the opening and closing process.

DE 101 60 240 A1 discloses a folding canopy whose front canopy section which contains the canopy peak is pivotably mounted, by means of a four-bar-mechanism device, on a central frame part of the canopy linkage in such a way that, during the opening and storage of the folding canopy, said front canopy section is moved rearward over the central canopy section in a parallel pivoting movement, and covers the stored folding canopy at the upper side with equally-curved alignment.

DE 38 37 522 C2 discloses a folding canopy whose front roof links, which bear the roof peak, pivot with respect to the rear roof links about a transverse pivot axle during the opening and storage of the folding canopy, so that when the folding canopy is stored, the roof peak is stored with its upper side pointing downward on the canopy.

DE 199 39 954 A1 presents a folding canopy whose front bow which forms the roof peak is movable in a continuous fashion relative to the front lateral roof links between a closed position and a half-open position, while the lateral roof links remain in the closed position of the folding canopy.

Each of said folding canopies contains an autonomous structural design in order to be able to carry out the desired movement profile of the movable canopy or roof peak.

The invention is based on the object of providing a folding canopy as specified in the introduction which, with little expenditure, can be produced in different embodiments for different user requirements, and of specifying a method for producing a folding canopy of said type.

The object is achieved according to the invention by means of a folding canopy having the features of claim 1.

The fastening base which is arranged in particular on a front section of the canopy linkage provides a standard attachment position on the folding canopy or its linkage, to which different roof or canopy peaks can be attached, but with the overall dimensions of the folding canopy always remaining uniform, so that each folding canopy produced in this manner can be attached to the associated cabriolet substantially without conversion parts or adaptations.

In order to complete the folding canopy, in each case one canopy peak is attached to the fastening base, which canopy peak is selected from a group of at least two canopy peaks which are formed differently in particular with regard to their movement functionalities, but have the same connecting dimensions.

A modular canopy concept is thereby realized, which canopy concept is based on one basic linkage of the folding canopy including the seals arranged thereon, with the basic linkage, including the mounting on the vehicle and a drive device, being of substantially identical design for all variants.

By selecting from different canopy peaks, it is possible to meet respective customer requirements with regard to a simple or complex folding canopy, for example with manually or partially manual or automatic operation. Here, despite improved benefit, it is possible for the costs to be reduced by using identical parts or a substantially uniform linkage and required additional components.

The object is also achieved, in the case of a folding canopy for a cabriolet vehicle, which folding canopy has a main linkage and a front roof or canopy part, in the embodiment of a modular canopy system in that it is possible for differently-designed front roof or canopy parts to be fastened by means of one interface of the main linkage substantially without fundamental changes thereto, so that at least two fundamental variants of partial opening possibilities move a front bow of the front roof or canopy part in a different way from the closed to the opened or stored state.

Advantageous embodiments of the invention are specified in the subclaims which refer back to the two coordinate main claims.

The fastening base is preferably formed on a respective lateral frame part of a front canopy section. The lateral frame part is expediently itself mounted on the linkage by means of a four-bar mechanism and, during the storage of the folding canopy, is stored in a pivoting movement in the same direction towards the rear canopy parts. It is however also possible for some other linkage part to form the fastening base.

In a preferred embodiment, the canopy peak has in each case one lateral mount part or roof frame part which is prepared for attachment to the fastening base and on which a front bow is pivotably mounted by means of links of a four-bar or multi-bar mechanism. In this way, the front bow of the canopy peak can, during the storage of the folding canopy, be pivoted for example in a parallel pivoting movement over the canopy parts which adjoin in the rearward direction. The front bow therefore assumes, in the stored position of the folding canopy, a position arranged comparatively far rearward, so that the space required for the stored folding canopy between the lateral linkages in the vehicle longitudinal direction is reduced. Said advantage can for example be utilized when storing the folding canopy behind two rollover protection bars.

In the embodiment specified above, the front bow can be coupled to a closure hook of a locking device for fixing the canopy peak to a windshield cowl, so that no separate drive is required for pivoting said front bow. In an alternative configuration, the front bow can be coupled, for common movement, to a movement-transmitting main linkage of the canopy linkage. The storage movement of the folding canopy is thereby transmitted to the front bow.

In a further embodiment, the canopy peak comprises in each case one lateral roof frame part which is prepared for attachment to the fastening base and on which a front bow is mounted by means of a fixed pivot axle and can be folded rearward from its closed position into its open position. Said embodiment is of particularly simple design and is particularly suitable for manual operation, though a drive is also possible.

According to a third embodiment, the canopy peak comprises in each case one lateral roof frame part which is prepared for attachment to the fastening base and on which a front bow is movable in a substantially translatory fashion by means of a mount device. The mount device expediently comprises a guide rail on which a joint device, which is connected to the front bow, is mounted in a movable fashion.

It is therefore also possible in the second and third embodiments for the front bow to be stored in a space-saving manner in a position offset rearward with respect to the linkage.

The or each lateral roof frame part preferably comprises, at the front side, a locking device which holds the roof frame part locked against a windshield cowl when the folding canopy is closed.

Here, if the locking device of each roof frame part or of each canopy peak is arranged on the folding canopy in a uniform position, it is possible to use the different canopy peaks without it being necessary to carry out alterations to the position of the matching lock part on the windshield cowl.

Each of said locking devices can be formed such that it is actuated manually by means of a respective actuating lever.

On the other hand, the locking devices of the two lateral roof frame parts can be actuated by means of an actuating unit which is arranged centrally on the canopy peak and which is connected to the locking devices.

In one expedient configuration, it can be provided that, by releasing the linkage coupling of the front bow or its mechanism, a partially open driving position is possible even with manual actuation.

The second object is achieved according to the invention by means of a method having the features of claim 15. Advantageous method variants are specified in the associated subclaims.

A folding canopy according to the invention is explained in more detail below on the basis of exemplary embodiments and with reference to the drawing, in which:

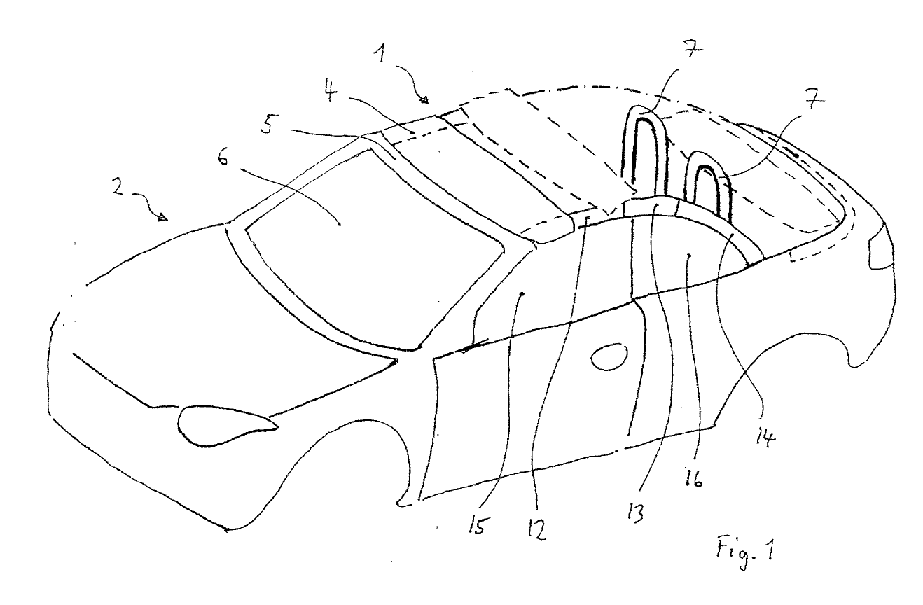

FIG. 1 shows, in a perspective plan view, a schematic illustration of a cabriolet with a folding canopy in the closed position;

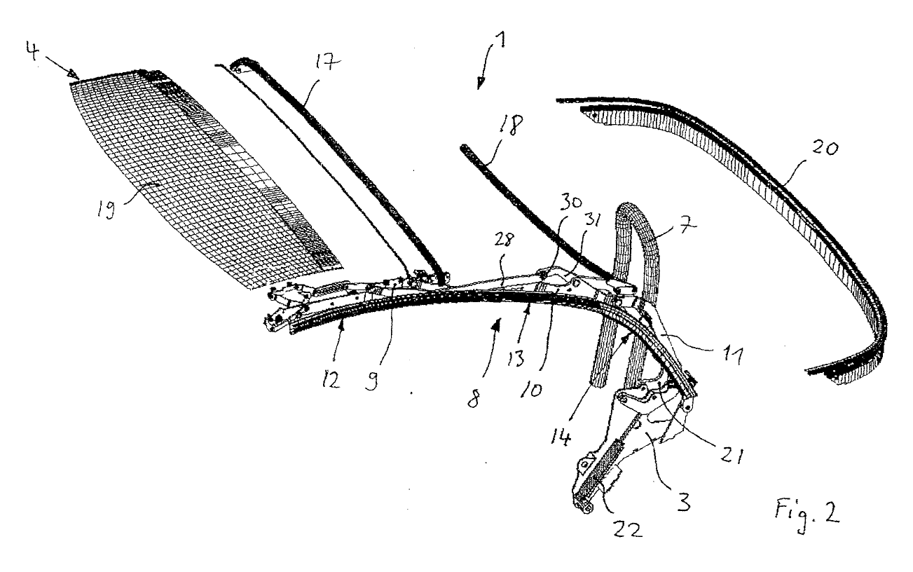

FIG. 2 shows, in a perspective plan view, the folding canopy with a first embodiment of the canopy peak, in the closed position;

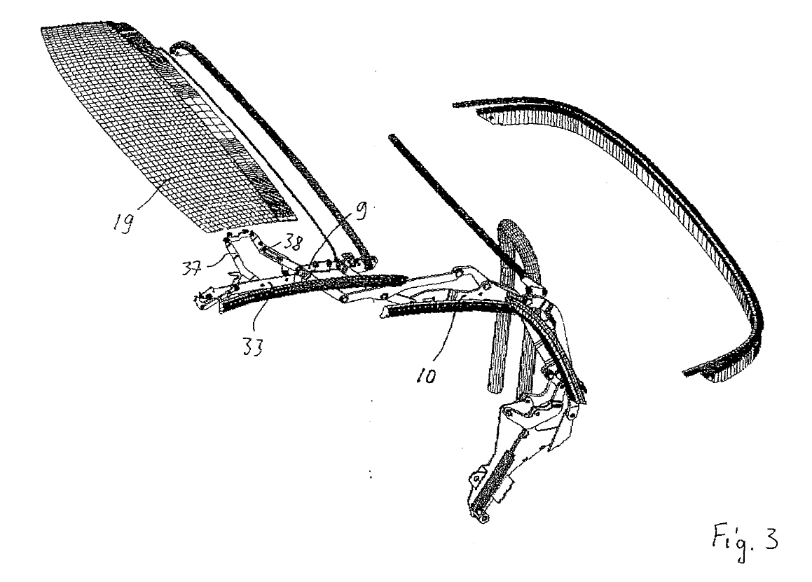

FIG. 3 shows, in a perspective plan view, the folding canopy as per FIG. 2 in an intermediate position during the opening process;

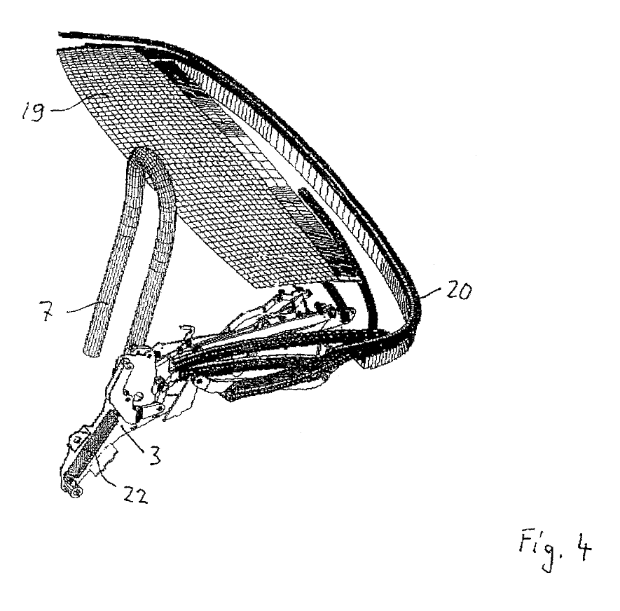

FIG. 4 shows, in a perspective plan view, the folding canopy as per FIG. 2 in an open storage position;

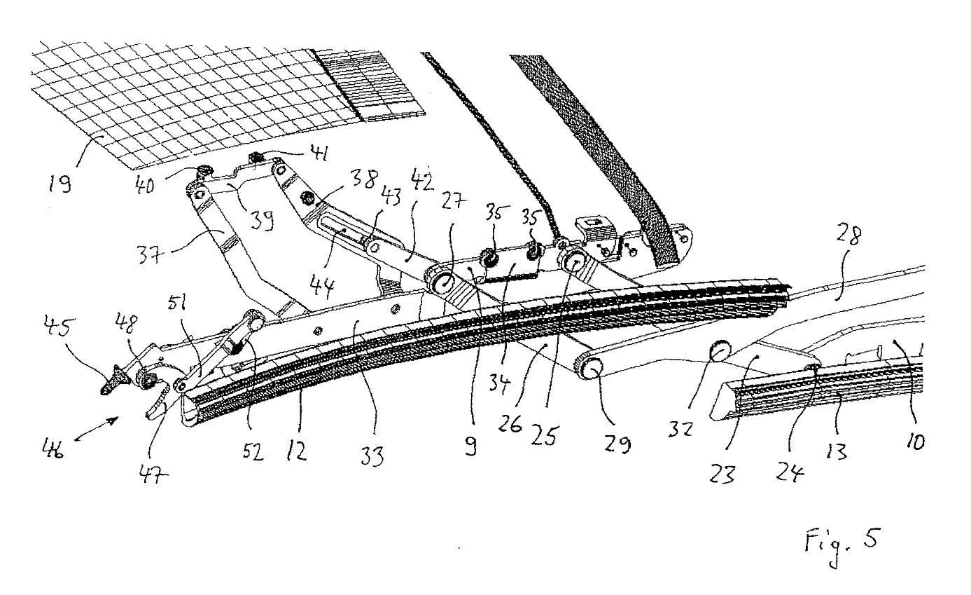

FIG. 5 shows, in a detail illustration which is enlarged in relation to FIG. 3, a front section, which comprises the canopy peak, of the folding canopy;

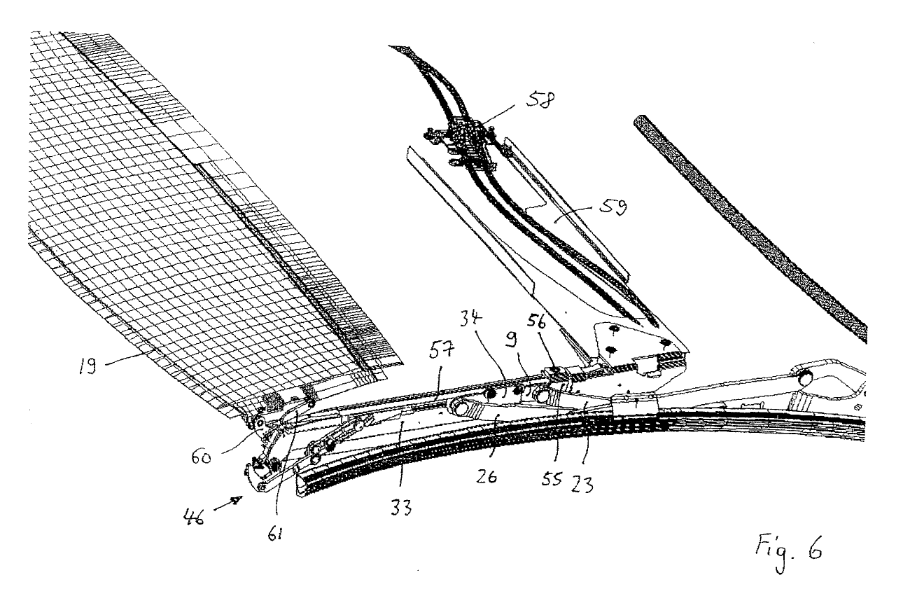

FIG. 6 shows, in a perspective plan view, the folding canopy with a second embodiment of the canopy peak, in the closed position;

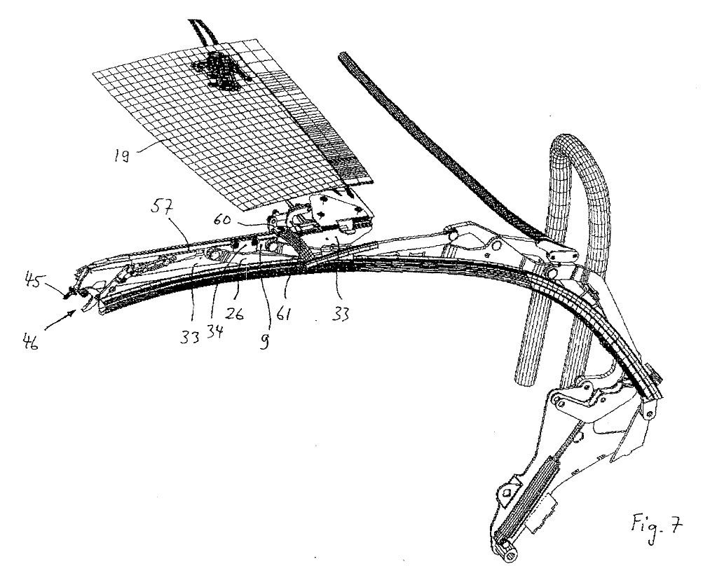

FIG. 7 shows, in a perspective plan view, the folding canopy as per FIG. 6 in an intermediate position during the opening process;

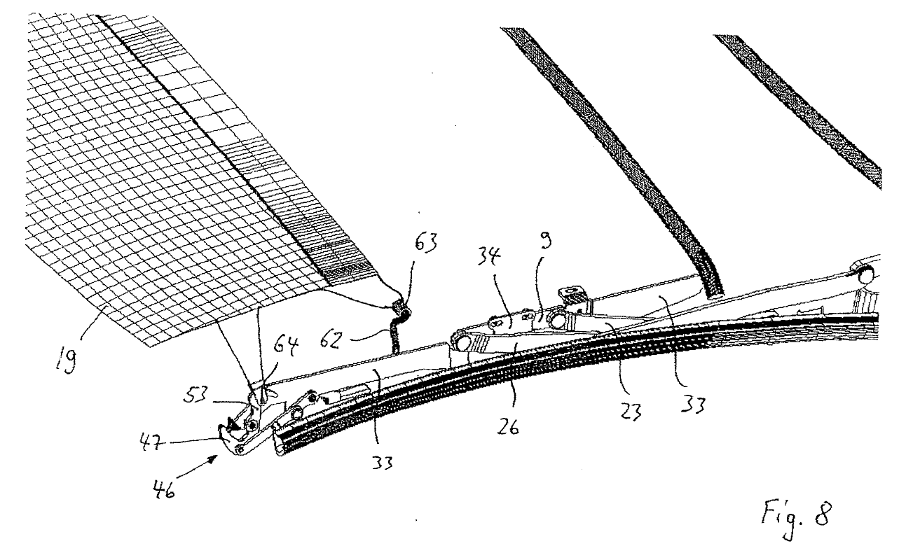

FIG. 8 shows, in a perspective plan view, the folding canopy with a third embodiment of the canopy peak, in the closed position;

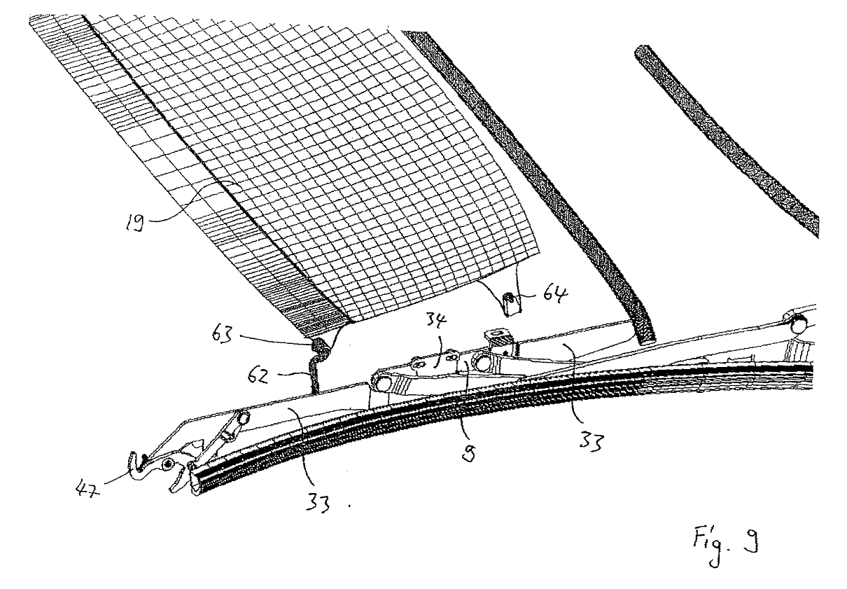

FIG. 9 shows, in a perspective plan view, the folding canopy as per FIG. 8 in an intermediate position of the canopy peak during the opening process;

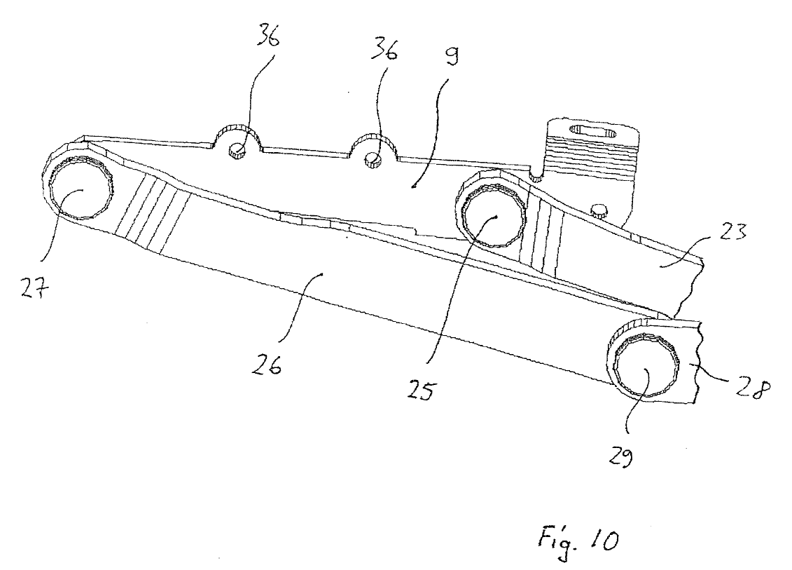

FIG. 10 shows, in a perspective plan view and in an enlarged illustration, a fastening base on the basic linkage of the folding canopy for the attachment of a respective canopy peak;

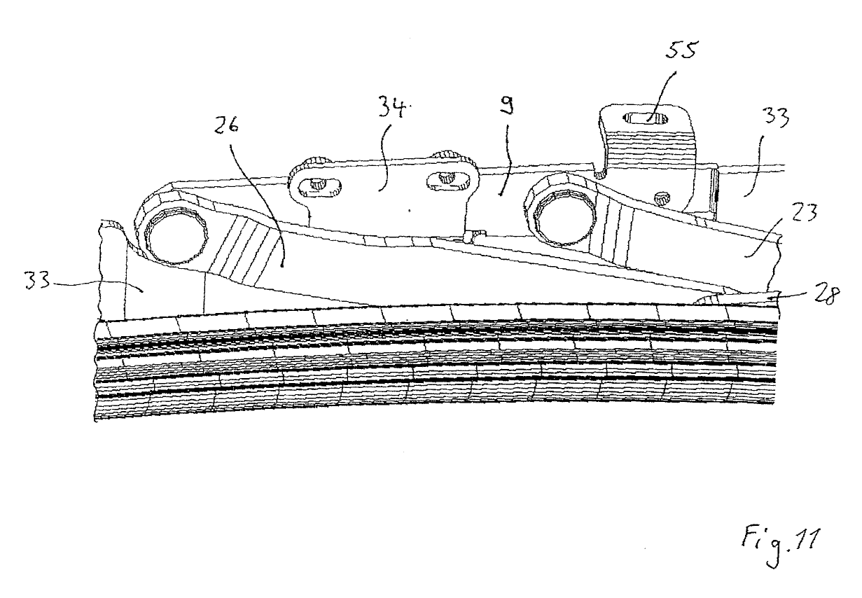

FIG. 11 shows, in a perspective plan view and in an enlarged illustration corresponding to FIG. 10, the fastening base with a mount component of the canopy peak attached thereto;

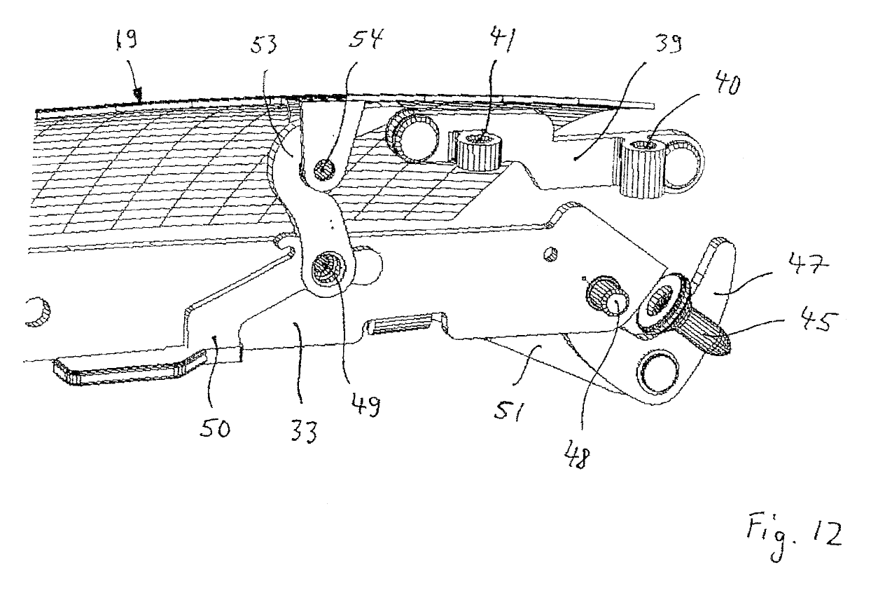

FIG. 12 shows, in a perspective plan view, a front section of a lateral roof frame with a locking device attached thereto for fixing the roof frame to a windshield cowl of the cabriolet when the locking hook is closed;

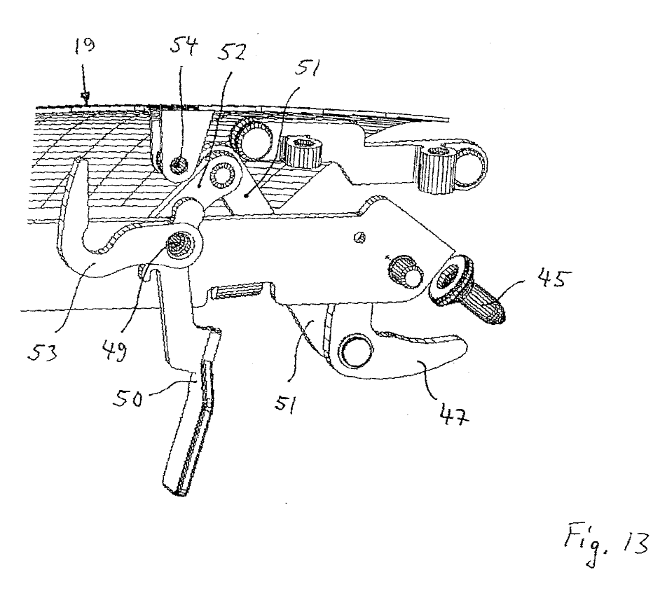

FIG. 13 shows, in a perspective plan view as per FIG. 12, the front section of the lateral roof frame with the locking device when the locking hook is partially open; and

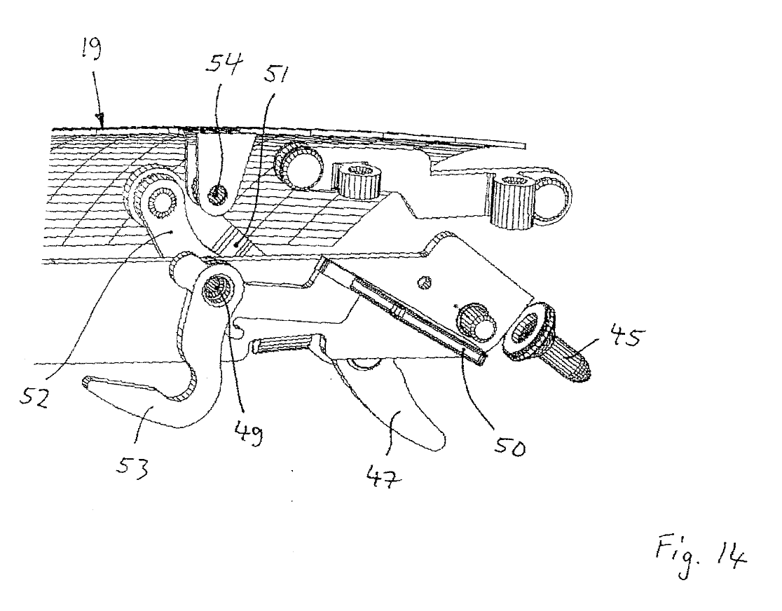

FIG. 14 shows, in a perspective plan view as per FIG. 12, the front section of the lateral roof frame with the locking device when the locking hook is fully open.

A folding canopy 1 of a cabriolet 2 is mounted in a movable fashion on a main mount 3 of the body and is adjustable between a closed position, in which a canopy peak 4 is arranged on a windshield cowl 5 above the front window 6 (FIGS. 1 and 2), and a storage position (FIG. 4) in which said canopy peak 4 is stored on the vehicle at the rear side behind two rollover bars 7. The folding canopy 1 has a canopy linkage 8 which is of symmetrical construction with respect to a vertical longitudinal central plane and comprises, at both sides, in each case one front linkage or frame part 9, a central linkage or frame part 10 and a rear linkage or frame part 11 with in each case associated lining parts and seals 12, 13 and 14, which, in the closed position of the folding canopy 1 illustrated in FIG. 1, run substantially along an upper edge of the at least one side window 15 and 16 of the vehicle. Two support bows 17 and 18 which are illustrated by way of example and which extend between the right-hand and the left-hand linkage train are provided for supporting a canopy material (not illustrated). The canopy material extends from an areal front bow 19 of the canopy peak 4 to a rear-side tensioning bow 20. The rear frame part 11, which constitutes a main pillar, and a main link 21 are pivotably articulatedly connected to the main mount 3 and, in a known way, together with the central frame part 10, form a four-bar mechanism which bears the folding canopy 1 and mounts the latter in a movable fashion. A hydraulic cylinder 22 pivots the four-bar mechanism and therefore the folding canopy 1. A canopy linkage of said type is in this respect fundamentally disclosed in DE 101 60 240 A1, to which reference is made in this regard.

At the front end of the central frame part 10 (see in particular FIG. 5), a rear link 23 of a link device, which mounts the front frame part 9, is pivotably mounted in a joint 24. The opposite end of the rear link 23 is pivotably articulatedly connected, with a joint 25, to the rear section of the front frame part 9. A front link 26 of the link device is pivotably attached at one side to the front frame part 9 in a joint 27 and at the other side to the front end of an intermediate link 28 in a joint 29. The intermediate link 28 is articulatedly connected at its rear end by means of a joint 30 to a control section 31 of the main link 21. In addition, the intermediate link 28 and the rear link 23 are pivotably connected to one another by means of a joint 32.

The front frame part 9 forms a fastening base for attaching a frame part 33 of the canopy peak 4. The frame part 33 has a fastening tongue 34 which is fastened to the front frame part 9 by means of two screws 35 or bolts which engage through bores 36 in the front frame part 9. A front and a rear auxiliary link 37 and 38 are pivotably mounted at one side on the frame part 33 and at the other side on a load-bearing part 39 in a four-bar-mechanism arrangement. The front bow 19 is fastened to two mount points 40 and 41 of the load-bearing part 39 (an outer side section of the front bow 19 is not illustrated in the figures so as not to obscure components situated under it).

The pivoting of the auxiliary links 37 and 38 takes place by means of a coupling link 42 which is rotationally fixedly connected to the front link 26 of the canopy linkage 8 and, with an engagement part or pin 43, is guided in a movable fashion in a slotted guide 44 of the rear auxiliary link 38.

A centering pin 45, which engages into an associated receptacle on the windshield cowl when the folding canopy 1 is closed, and a locking device 46 are arranged at the front end of the frame part 33. The locking device 46 comprises a closure hook 47 (see also FIGS. 12 to 14) which is mounted in a joint 48 on the frame part 33 and, when the folding canopy 1 is closed (FIGS. 2 and 12), engages behind an anchor on the windshield cowl of the vehicle. An actuating lever 50 which is pivotably mounted on the frame part 33 in a joint 49 is coupled to the closure hook 47 by means of two coupling levers 51 and 52. A second closure hook 53 which is rotationally fixedly connected to the actuating lever 50 engages, when the front bow 19 is closed, behind a locking bolt 54 which is attached to the underside of said front bow 19.

The support bow 17 is in this exemplary embodiment fastened to a rear end of the frame part 3. Further components for tensioning the canopy material or an inner lining can be fastened to the frame part 33.

In order to open and store the folding canopy 1 (movement from FIG. 2 to FIG. 4), the closure hooks 47 and 53 are firstly unlocked manually by means of the actuating lever 50. The canopy linkage 8 is subsequently pivoted by means of the hydraulic cylinder 22 into the storage position, with the canopy peak 4 being pivoted rearward with respect to the front frame part 9 as a result of the positive coupling of the front bow 19. The front bow 19 can thereby be moved over the two rollover bars 7 into a rear storage position.

The closing process of the folding canopy 1 takes place with the opposite sequence of movements.

In an alternative configuration, the front bow 19 can be coupled to a motor-driven locking device and pivoted rearward during the unlocking. The coupling link 42 is dispensed with in this case.

Also possible is a configuration in which the second closure hook 53 can be opened when the first closure hook 47 is closed, so that the front bow 19 can be moved into an open position while the folding canopy 1 otherwise remains closed.

A canopy peak (see FIGS. 6 and 7) which can alternatively be attached to the fastening base or to the front frame part 9 likewise comprises the frame part 33 which is fastened by means of the fastening tongue 34 and the screws 35 which engage through the bores 36. An additional fastening is provided to the lug 55 by means of a screw 56. A guide rail 57 is fastened to the frame part 33, on which guide rail 57 a mounting carriage is mounted in a movable fashion and such that it can be moved by a drive device 58. The drive device 58 is mounted on a cross member 59 which connects the two frame parts 33 and is connected by means of drive cables to the mounting carriage. The mounting carriage bears a link device with two links 60 and 61 in a four-bar-mechanism arrangement which movably mount the load-bearing part 39 of the front bow 19. The mounting of the front bow 19 on the guide rail 57 takes place for example by means of the adjusting device disclosed in DE 102 03 204 A1.

The locking device 46 is coupled to the drive device 58 for example in such a way that, during the movement of the mounting carriage or of the front bow 19 into its open position, the closure hook 47 is unlocked. However, it is also possible for the actuation of the locking to be independent of the movement of the front bow 19, so that here, too, a partial opening of the front bow 19 is possible when the canopy linkage is still locked against the windshield cowl 5.

A further canopy peak which can alternatively be attached to the fastening base (see FIGS. 8 and 9) comprises the frame part 33 which is fastened in the same way as the two embodiments described above. A mount arm 62 which is attached to the frame part 33 forms a fixed pivot axle 63 on which the front bow 19 is pivotably mounted. Attached to the underside of the front bow 19 is a locking bolt 64 which can be locked by the closure hook 53. The locking device 46 is constructed corresponding to the illustration in FIGS. 12 to 14. After the manual unlocking of the two closure hooks 47 and 53, the front bow 19 can be pivoted rearward, whereupon the folding canopy is stored rearward in the manner already described. A motor drive or motor-driven locking is also possible here.

It is therefore shown that different movements of the front bow for setting intermediate open positions and for storage are possible in a simple manner with the one canopy linkage or main linkage and by supplementing different canopy peaks without further conversion or adaptation measures.

### LIST OF REFERENCE SYMBOLS

| | |
|---|---|
| 1 | Folding canopy |
| 2 | Cabriolet |
| 3 | Main mount |
| 4 | Canopy peak |
| 5 | Windshield cowl |
| 6 | Front window |
| 7 | Rollover bar |
| 8 | Canopy linkage |
| 9 | Front frame part |
| 10 | Central frame part |
| 11 | Rear frame part |
| 12 | Front seal |
| 13 | Central seal |
| 14 | Rear seal |
| 15 | Side window |
| 16 | Side window |
| 17 | Support bow |
| 18 | Support bow |
| 19 | Front bow |
| 20 | Tensioning bow |
| 21 | Main link |
| 22 | Hydraulic cylinder |
| 23 | Rear link |
| 24 | Joint |
| 25 | Joint |
| 26 | Front link |
| 27 | Joint |
| 28 | Intermediate link |
| 29 | Joint |
| 30 | Joint |
| 31 | Control section |
| 32 | Joint |
| 33 | Frame part |
| 34 | Fastening tongue |
| 35 | Screw |
| 36 | Bore |
| 37 | Front auxiliary link |
| 38 | Rear auxiliary link |
| 39 | Load-bearing part |
| 40 | Mount point |
| 41 | Mount point |
| 42 | Coupling link |
| 43 | Pin |
| 44 | Slotted guide |
| 45 | Centering pin |
| 46 | Locking device |
| 47 | Closure hook |
| 48 | Joint |
| 49 | Joint |
| 50 | Actuating lever |
| 51 | Coupling lever |
| 52 | Coupling lever |
| 53 | Second closure hook |
| 54 | Locking bolt |
| 55 | Lug |
| 56 | Screw |
| 57 | Guide rail |
| 58 | Drive device |
| 59 | Cross member |
| 60 | Link |
| 61 | Link |
| 62 | Mount arm |
| 63 | Pivot axle |
| 64 | Locking bolt |

1. A folding canopy for a cabriolet vehicle having a canopy linkage and having a canopy peak which is attached to the canopy linkage,
characterized
in that the canopy linkage has a fastening base which is prepared for the attachment of different canopy peaks, and
in that, in order to complete the folding canopy, in each case one canopy peak is attached to the fastening base, which canopy peak is selected from a group of at least two canopy peaks which are formed differently in particular with regard to their movement functionalities, but have the same connecting dimensions.

2. The folding canopy as claimed in claim 1,
characterized in that the fastening base is formed on a respective lateral frame part of a front canopy section.

3. The folding canopy of claim 1,
characterized in that the canopy peak has in each case one lateral roof frame part which is prepared for attachment to the fastening base and on which a front bow is pivotably mounted by means of links of a four-bar or multi-bar mechanism.

4. The folding canopy of claim 3,
characterized in that the front bow is coupled to a closure hook of a locking device.

5. The folding canopy of claim 3,
characterized in that the front bow is coupled, for common movement, to a movement-transmitting main linkage of the canopy linkage.

6. The folding canopy of claim 1,
characterized in that the canopy peak has in each case one lateral roof frame part which is prepared for attachment to the fastening base and on which a front bow is mounted by means of a fixed pivot axle and can be folded rearward from its closed position into its open position.

7. The folding canopy of claim 1,
characterized in that the canopy peak has in each case one lateral roof frame part which is prepared for attachment to the fastening base and on which a front bow is movable in a substantially translatory fashion by means of a mount device.

8. The folding canopy of claim 6,
characterized in that the or each lateral roof frame part has, at the front side, a locking device which holds the roof frame part locked against a windshield cowl when the folding canopy is closed.

9. The folding canopy of claim 8,
characterized in that the locking device of each roof frame part or of each canopy peak is arranged on the folding canopy in a uniform position.

10. The folding canopy of claim 8,
characterized in that each locking device is actuated manually by means of a respective actuating lever.

11. The folding canopy of claim 8,
characterized in that the locking devices of the two lateral roof frame parts are actuated by means of an actuating unit which is arranged centrally on the canopy peak and which is connected to the locking devices.

12. The folding canopy of claim 8,
characterized in that each locking device has a second locking hook which is coupled to its locking hook, by means of which second locking hook the movable front bow can be locked against the roof frame part in the closed position of the folding canopy.

13. The folding canopy of claims of claim 1,
characterized in that said folding canopy is provided for storage behind a rollover protection device of the cabriolet.

14. A folding canopy of a cabriolet which has a main linkage and a front roof or canopy part,
characterized
in that it is possible for differently-designed front roof or canopy parts to be fastened by means of one interface of the main linkage substantially without fundamental changes thereto, so that at least two fundamental variants of partial opening possibilities move a front bow of the front roof or canopy part in a different way from the closed to the opened or stored state.

15. A method for producing a folding canopy of a cabriolet,
characterized by:
a) providing a canopy linkage which is formed without a canopy peak and which is suitable for the attachment of different canopy peaks;
b) selecting a canopy peak from a group of at least two canopy peaks which are formed differently but have the same connecting dimensions; and
c) attaching the selected canopy peak to a universal fastening base, which is suitable for different canopy peaks, of the canopy linkage.

16. The method of claim 15,
characterized in that the group of canopy peaks has a canopy peak with a front bow which is pivotable rearward about a pivot axle which is fixed to the linkage.

17. The method of claim 15,
characterized in that the group of canopy peaks has a canopy peak with a front bow which is pivotable in parallel by means of a four-bar or multi-bar mechanism.

18. The method of claim 15,
characterized in that the group of canopy peaks has a canopy peak with a front bow which is movable in a substantially translatory fashion on a respective lateral roof frame part of the canopy peak.
